(19) United States
(12) Patent Application Publication
(10) Pub. No.: US 2016/0110662 A1
(43) Pub. Date: Apr. 21, 2016

(54) Production Simulation

(71) Applicant: HEWLETT-PACKARD DEVELOPMENT COMPANY, L.P., Houston, TX (US)

(72) Inventors: Gary J. Dispoto, Palo Alto, CA (US); Jun Zeng, Palo Alto, CA (US); Gidi AMIR, Nes Ziona (IL); Noam Shaham, Nes Ziona (IL)

(21) Appl. No.: 14/888,033

(22) PCT Filed: May 22, 2013
(86) PCT No.: PCT/US2013/042152

§ 371 Date: Oct. 29, 2015

(51) Int. Cl. G06Q 10/06

(52) U.S. Cl. CPC G06Q 10/067; G06Q 10/0633

(57) ABSTRACT

Examples disclosed herein relate to simulating production of an order. In one implementation, a processor extracts information about process flow of an order through resources, resource policy, and prioritization within the production environment from information related to the fulfillment of the previous orders. The processor may create a simulation of the fulfillment of new orders within the production environment based on the extracted information.

### BACKGROUND

A production environment may involve multiple resources, such as labor and equipment, for fulfilling orders. For example, a print service provider may fulfill custom client orders using specialized equipment, such as a printer and binder. Managing the production environment may involve moving multiple custom orders through the different resources simultaneously.

### BRIEF DESCRIPTION OF THE DRAWINGS

The drawings describe example embodiments. The following detailed description references the drawings, wherein:

FIG. 1 is a block diagram illustrating one example of a computing system to simulate the production of an order.

FIG. 2 is a flow chart illustrating one example of a method to simulate the production of an order.

FIG. 3 is a flow chart illustrating one example of a method to simulate the production of an order.

### DETAILED DESCRIPTION

In one implementation, a simulation of producing a set of orders in a production environment, such as a print service provider factory, is automatically created based on a machine learning of an event log showing the events of producing previous orders within the production environment, such as the resources and labor interactions with the previous order. The simulation may be based on additional characteristics of the previous orders, such as the order arrival time, expected due time, number and types of products required, pricing, customer The simulation may be based, for example, on selected orders to be simulated, and the process to follow for the selected orders may be based on similar previous orders. The simulated orders may reflect actual incoming orders or orders input by an administrator to reflect anticipated trends of future incoming orders. In some cases, priority information about the production environment may be automatically learned from the event log and order information. For example, the event log may be analyzed by a processor to determine rules about client order, equipment, and labor prioritization. In some cases, resource policies specific to the particular production environment may be automatically learned from the event log and order information. For example, a capacity of equipment used in the production environment may be learned based on the event log.

An automatic simulation may be useful for custom products and orders. For example, the production of different products may use a different set of resources in series or in parallel. The priority of the different orders may differ, such as based on service level agreements, price, profit margin, or other factors. An automatic simulation may account for the different factors associated with the different orders. Providing an automatic simulation based on an event log allows a simulation to be created without time consuming data entry. It allows for more accurate forecasting and allows the simulation to be based on how the specific production environment operated in the past, which may be more easily and accurately learned from the event log than from input from a worker associated with the production environment. The simulation may provide valuable data to the production environment, such as information about an estimated completion time if a particular set of orders is to be fulfilled or the production environment's overall performance in terms of service, revenue, or profit where the factory undertakes a particular set of orders. The impact of an anticipated demand trend may be evaluated with the automated simulation such that capacity of equipment resources and/or labor may be determined. The automated simulation may allow the production environment to be better prepared to successfully fulfill an anticipated set of orders. The simulation may be used to determine a manner of running the production environment to meet an objective, such as maximizing quality of service or profits.

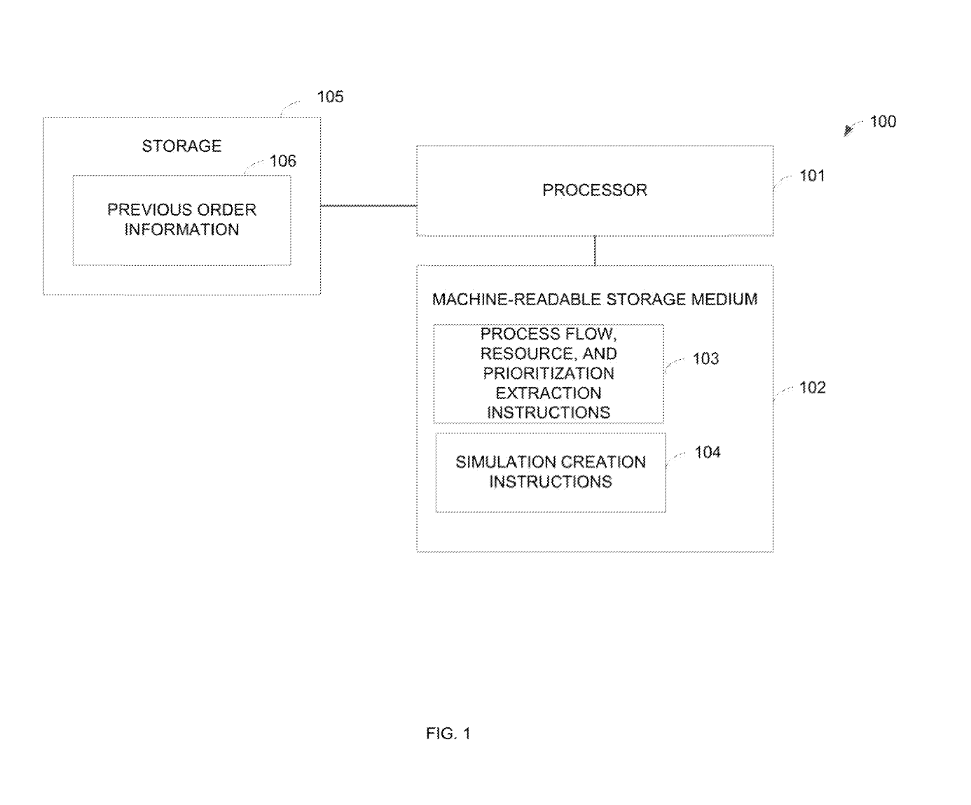

FIG. 1 is a block diagram illustrating one example of a computing system to simulate the production of an order. The computing system 100 may be used to simulate a group of orders in a production environment. The production environment may be, for example, a print service provider environment for creating custom print products. In one implementation, the production environment is an information technology environment. For example, the information technology environment may be used to resolve customer orders or support tickets for addressing information technology issues. The computing system 100 may include a processor 101, a machine-readable storage medium 102, and a storage 105. The computing system 100 may be included in a single apparatus or may be included in multiple apparatuses communicating via a network.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The storage 105 may be any suitable storage accessible by the processor 101. The storage 105 may store previous order information 106. The previous order information 106 may store information related to the fulfillment of previous orders associated with the production environment. For example, the previous order information 106 may include event log information related to the hand off of the product between equipment and resources. The previous order information 106 may include information about events associated with an order and a time stamp and/or resource associated with each event. The storage 105 or a separate storage may include a database of orders. The orders may be associated with a set of hand offs between resources in the previous order information 106. The order information may include a description of previous orders, including order arrival time, expected due time, number and types of products required, pricing, and customer. The event log and order information may be combined or separated in any suitable format, such that there may be one or more storages for the information.

The processor 101 or another processor may log the data and/or process the logged data for further analysis. The event logging involve collecting, organizing, and storing logged data. The previous order information 106 may include any suitable data related to the operation of the production environment, such as data related to a service request routed through production lines or a service fulfillment chain. In one implementation, the processor 101 performs additional operations to organize the information. For example, the data may be grouped by a session, order, or other aggregate unit. The data may be analyzed to determine the correctness of the data. For example, an order may be analyzed from multiple perspectives to determine whether there are any inconsistencies, such as redundancies or missing entries. The previous order information 106 may be analyzed from a view of the order compared to an analysis from the view of resources (e.g., labor and equipment). The activity/event and time stamp may be analyzed to determine the presence of the inconsistencies, and an inconsistency may be automatically corrected prior to further analysis of the data in the previous order information 106.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 105 may be, for example, a computer readable non-transitory medium. The machine-readable storage medium 102 may include process flow, resource, and prioritization extraction instructions 103 and simulation creation instructions 104.

The process flow, resource, and prioritization extraction instructions 103 may include instructions to create, using automated learning techniques, a mapping of a process flow of creating a custom product in a production environment based on the previous order information 106. The automated learning may include evaluating the previous order information 106 to extract profiles of the previous orders and resource use in the production environment. The process flow, resource, and prioritization extraction instructions 103 may include instructions to create a graph or other structure representing the production flow through the production environment. The production flow may be analyzed by the processor 101 to uncover information about the production environment, such as information about the flow of particular types of orders through the production environment resources. For example, an order profile may be created for a particular order and/or type of order.

The processor 101 may analyze the previous order information 106 to determine resource profiles of resources in the production environment. The resource profile associated with a particular resource may include information about, for example, the capability, capacity, availability, speed, cost, and interruption pattern of the resource.

The process flow, resource, and prioritization extraction instructions 103 may further include instructions to learn prioritization rules based on an analysis of the previous order information 106. For example, priority among types of order or types of resources may be learned. The graph and the information learned from the graph may be stored for use in creating a simulation of the production environment.

The simulation creation instructions 104 may include instructions to create a simulation of new orders in the production environment based on the process flow, resource, and prioritization information learned from the previous order information 106. Basing the simulation on information extracted from the operations of the specific production environment may result in a more accurate simulation. The simulation creation instructions 104 may include instructions to receive information related to a request and may format or edit the information to be compatible to a system order. Similar previous orders may be determined, and the information stored related to the mapping, such as the production flow, prioritization information, and resource profiles, may be applied according to the determined similar previous orders. Multiple orders may simultaneously be simulated such that prioritization is determined between the orders and resources based on the information related to the mapping. The orders may be received as related to customer intent, and the processor may translate the customer intent information into a new order to be simulated. Performance metrics may be determined and output that allow a user to receive information about the performance of the system as if the hypothetical orders were fulfilled.

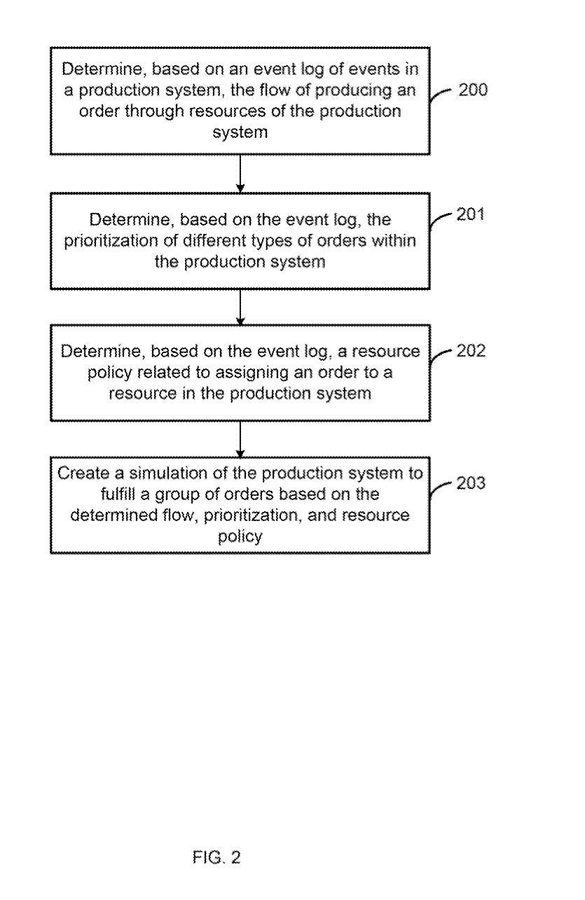

FIG. 2 is a flow chart illustrating one example of a method to simulate the production of an order. Information about a production environment may be automatically determined based on an event log representing past operations of the production environment, such as how an order is passed between resources. The path and time period of passing of the order between resources, such as labor and equipment resources, may be used by a processor to learn information about the production environment. The priority of different orders and resources may be learned from the event log information, and the event log information may be analyzed by a processor to automatically learn operating policies related to the production environment, such as the capacity of a worker or equipment. The operating policies may include, for example, prioritization policies and resource assignment policies. Information about the resources in the production environment may be automatically extracted, such as information about the capacity and capability of a worker and/or equipment. The learned information may be used to simulate new orders within the production environment. The method may be implemented, for example, by the processor 101 of FIG. 1.

Beginning at 200, a processor determines, based on an event log of events in a production system, the flow of producing an order through resources of the production system. The processor may create a graph representing the flow of producing an order through resources of a production system. The production system may be any suitable system for producing a product or service, and an order may be any suitable request for a product or service to be produced by the production system. For example, the production system may be a print service provider producing a custom print product. The production system may be an information technology system for resolving information technology issues.

The event log may be any information about the passing of an order of a product or service between resources in the production system. For example, the event log may include time stamps about information as the order is passed from one resource, such as a laborer or equipment, to another. The event log may include information in addition to the flow of the order production. For example, the event log may include information related to health of a resource, interruptions caused by the failure of a resource, and replenishment of the consumables for a resource.

As an example a graph may be created where each node represents a resource, such as a laborer or piece of equipment. The edges in the graph may represent the flow of a particular order through the nodes. The graph may be represented in any suitable manner. For example, the graph may be stored as an order associated with a list of resources in a particular order. Time stamp or other information may be associated with the list of resources. In one implementation, multiple orders in an event log are analyzed, and aggregate flow information is created to represent the flow through resources of a particular type of order. For example, the graph may be simplified to represent a set of paths of different types of orders as opposed to the path of each of the individual orders.

The graph may include a typical flow and an exceptional flow where there is an exception or interruption to the typical flow process. For example, a particular flow may be determined for an order type, and orders that did not follow that flow may be analyzed to determine whether an exception occurred, such as whether particular equipment was unavailable. An exception in the flow may represent, for example, a circumstance where a resulting product did not meet quality standards, and the product is sent back through some of or all of the production flow to remake the product. The graph may have multiple branches where a first branch is the typical route through the resources, and alternative branches are used in exceptional cases. The graph may have different branches according to different factors, such as a different branch for the same product where it is created at a higher volume or during a different season.

Continuing to 201, a processor determines, based on the event log, the prioritization of different types of orders within the production system. For example, the processor may analyze the event log and learn patterns as to which types of orders are provided greater service levels. The processor may mine the event log data to learn patterns about which types of combinations of order content and service level agreements historically corresponded to a particular level of production priority. In one implementation, the learning is performed using a decision tree based on the content of the order, order service level, current production situation, seasonality, and other characteristics.

The prioritization information may include multiple prioritization rules where different prioritization rules are applied in different circumstances. For example, one prioritization rule may be applied during a particular time of day or season and another prioritization rule may be applied during a different time of day or different season. The prioritization rules may be related to particular resources. For example, a particular resource may accept a first type of order on a first priority basis.

Proceeding to 202, a processor determines, based on the event log, a resource policy related to assigning an order to a resource in the production system. For example, the processor may learn about how a particular resource is used within the production environment without receiving the information from a user. The processor may analyze the event log to determine the capability, capacity, availability, speed, cost, and/or interruption pattern associated with a particular resource. For example, the event log time stamps may reveal how many orders or pieces of an order were able to be processed on a piece of equipment at the same time. The time stamps may reveal the typically efficiency of a worker performing a particular type of task.

Moving to 203, a processor creates a simulation of the production system to fulfill a group of orders based on the determined flow, prioritization, and resource policy. For example, the production system may determine a flow of each order through the resources such that the different orders are prioritized based on the prioritization information and the resources are used according to the resource policies determined by the system. For example, the capacity of a resource may be used to determine how many of the orders may be processed by the resource at a time, and the prioritization rules may be used to determine how to prioritize the orders within the capacity of the resource.

In one implementation, the processor determines a flow for each of the orders based on the production flow through resources of similar previous orders. For example, a similarity of the order, such as the type of product or service, a customer intent for the product or service, the volume, the desired service level, and/or time of year, may be compared to previous orders to determine a similar order and/or set of orders. In some cases, there may be a set of production flows where each is associated with particular order features, and the new order is associated with the production flow where the features are closest to that of the order.

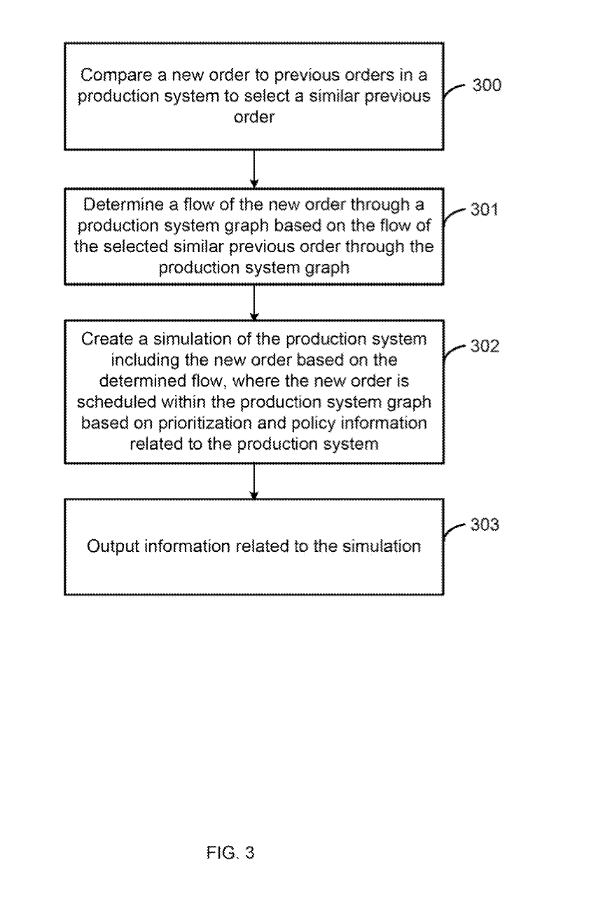

FIG. 3 is a flow chart illustrating one example of a method to simulate the production of an order. A new order may be added to a simulation, and in one implementation, a statistical demand profile is created from an event log including information about historical orders and their flow through the production environment, such as based on the order arrival frequencies, product types and numbers, sizes and dimensions, service levels, and expected due times information in the event log and/or historical order database. Based on the created demand profile, an artificial order stream is created that represents the current demand situation of production environment. The processor may alter the artificial order stream to reflect the management's anticipation of the demand change, such as to reduce the frequency of certain types of orders or increase the frequency of another type of orders. A production environment may be analyzed to output metrics related to the production environment when the new order is produced. The user may run the simulation to determine whether the order or group of orders may be accepted while still complying with particular guidelines, such as service level agreements. The simulation may reveal whether a desirability to add certain types of equipment or resources. The simulation may reveal better options for organizing the service fulfillment by using different workflows, prioritization schemes, or different resource assignment policies. The method may be implemented, for example, by the processor 101 of FIG. 1.

Beginning at 300, a processor compares a new order to previous orders in a production system to select a similar previous order. The new order may be received in any suitable manner. For example, the processor may generate a user interface for running a simulation in which a user may individually enter order information or upload a batch of orders. In some cases, the user may upload orders actually received from customers to run a simulation of the result in order to provide customers information, such as the likely completion time.

The processor may normalize an incoming request. For example, the new order may be provided by selecting specific parameters from a user interface for the simulation and/or provided by uploading a list of orders. If the orders for the simulation are not in a format compatible with the system, the processor may normalize the orders by determining order parameters from customer intent information. For example, orders from customers may be uploaded into the system for a simulation such that factory management may determine statistics, such as average completion time for the set of orders.

The processor may extract attribute value pairs from the order information. For example, the attributes may include service level, equipment type, labor type, and order volume. The attributes may include information about customer intent, such as attributes related to color, dimension, or finishing of a print product or information technology service category, information technology related equipment for an information technology issue. The values for the different attributes may be extracted and stored associated with the particular attribute. The processor may determine similarity scores for the attribute values to the attribute values of previous orders or to attribute values associated with order information of a particular production flow. The processor may then aggregate the similarity values between the two orders across the different attributes. The aggregate similarity score may be based on a sum of the individual attribute similarity scores. In some implementations, the attributes are weighted such that one attribute is given more importance in the aggregate similarity score than another attribute. The weights may vary based on the type of order. The processor may compare the aggregate similarity value of the new order to the different previous orders to determine previous orders most similar to the new order. For example, previous orders with an aggregate similarity score to the new order that is the highest, above a threshold, or in a particular top percentage of scores may be selected for use in determining the production resource path of the new order.

Continuing to 301, a processor determines a flow of the new order through a production system graph based on the flow of the selected similar previous order through the production system graph. In some cases, multiple previous orders may be selected, and the particular previous order production path may be selected based on additional factors, such as the capacity of a resource on the path and the number of other orders to simultaneously be processed by the resource.

Moving to 302, a processor creates a simulation of the production system including the new order based on the determined flow, where the new order is scheduled within the production system graph based on prioritization and policy information related to the production system. The prioritization information may be any information related to scheduling priorities in the production system. For example, a type of order or type of equipment may receive a preference. The prioritization information may be received in any suitable manner. The processor may access the information from a storage. In one implementation, the processor automatically determines the priority information based on an analysis of an event log or other information related to past operations of the production system. The processor may generate a user interface to displays the extracted priority information to a user and to allow a user to manually alter the priority information.

The resource profile information may be any suitable information related to how a resource is utilized in the production environment. The resource profile information may be information related to, for example, the speed of a particular resource for performing a task, the frequency of use of the resource, a capacity of the resource, or a time period availability of the resource. The resource information may include information about the health of the resource, such as the mean time to failure or the level of a consumable used by an equipment resource.

The processor may retrieve the policy information from a storage. In one implementation, the processor automatically determines the resource policy information based on an analysis of past operations of the production system. The processor may receive user input to manually update the automatically determined resource policy information.

The simulation may be performed by determining an acceptable production resource flow for each order and then scheduling the orders among the resources based on the prioritization and resource policy information. The processor may determine the prioritization based on learned prioritization rules from the production event logs such that the simulation is closely reflecting the reality of the production environment. For example, the capacity of a particular resource may be taken into account as to how many orders may be simultaneously scheduled for equipment or how quickly the different orders may be scheduled. The processor may determine multiple methods for scheduling the different orders based on the resource policy and may select among the different scheduling options based on the option that most preserves the preferred prioritization. The processor may determine the preferred prioritization, for example, based on maximizing a particular production environment objective.

Proceeding to 303, a processor outputs information related to the simulation. For example, metrics may be determined related to the particular resource, aggregate metrics may be determined related to the set of orders, or metrics may be determined for a particular order. The metrics may be related to the overall performance of the production environment, such as the throughput, revenue, profit, or service quality. The service quality may indicate, for example, the mean service delay, mean product cycle time, or on-time delivery rate. The metrics may be output to a user to evaluate.

In one implementation, a user may update resource policy, prioritization, and/or order information. For example, a different set of hypothetical order information may be uploaded. In some cases, the processor may generate a user interface that allows a user to manually change the resource policy and/or prioritization information to be different than that automatically learned by the system. For example, the system may create a simulation system according to how the production system has operated in the past, and the user may provide updated settings to run a new simulation to see the results if the production system were to be run in a different manner in the future. The metrics may allow a user to forecast the results of different orders being fulfilled within the production system.

1. A computing system, comprising:
a storage to store information related to the fulfillment of previous orders associated with a production environment; and
a processor to:
extract information about process flow of an order through resources, resource policy, and prioritization within the production environment from the information related to the fulfillment of the previous orders; and
create a simulation of the fulfillment of new orders within the production environment based on the extracted information.

2. The computing system claim 1, wherein the processor is further to:
compare a view of the previous order information based on at least one of an order, a part, and a product to a view of the previous order information based on a resource;
determine an inconsistency in the previous order information based on the comparison; and
update the previous order to remove the inconsistency.

3. The computing system of claim 1, wherein the processor is further to group events in the previous order information into sessions.

4. The computing system of claim 1, wherein creating the simulation comprises creating the simulation of a new custom order based on a degree of similarity of the new custom order to a past order.

5. The computing system of claim 1, wherein the production environment comprises a print service provider production environment to produce custom print orders.

6. A method, comprising:
determining, based on an event log representing the flow of previous orders through a production system, the flow of producing an order through resources of a production system;
determining, based on the event log, the prioritization of different types of orders within the production system;
determining, based on the event log, a resource policy related to assigning an order to a resource in the production system; and
creating, by a processor, a simulation of the production system to fulfill a group of orders based on the determined flow, prioritization, and resource policy.

7. The method of claim 6, wherein the policy comprises at least one of: capability, capacity, availability, speed, cost, and interruption pattern.

8. The method of claim 6, wherein the graph includes an exception flow related to cases where there is an exception to the typical flow process.

9. The method of claim 6, wherein creating a simulation comprises determining the flow of a new order through the production system based on the flow of a similar previous order through the production system.

10. The method of claim 6, wherein the prioritization information may include multiple prioritization rules where different prioritization rules are applied in different circumstances.

11. A machine readable non-transitory storage medium comprising instructions executable by a processor to:
compare a new order to previous orders in a production system to select a similar previous order;
determine a flow of the new order through a production system graph based on the flow of the selected similar previous order through the production system graph;
create a simulation of the production system including the new order based on the determined flow, wherein the new order is scheduled within the production system graph based on prioritization and policy information related to the production system; and
output information related to the simulation.

12. The machine readable non-transitory storage medium of claim 11, further comprising instructions to:
receive information about a customer intent; and
translate the customer intent into the new order, wherein the new order includes criteria related to the production system.

13. The machine-readable non-transitory storage medium of claim 11, further comprising instructions to select a similar previous order based on a comparison of at least one of service level, equipment type, labor type, and order volume of the new custom order to the previous order.

14. The machine-readable non-transitory storage medium of claim 11, further comprising instructions to determine the production system prioritization of order types based on an analysis of the production system graph.

15. The machine-readable non-transitory storage medium of claim 11, further comprising instructions to determine the production system policy information related to at least one of labor and equipment based on an analysis of the production system graph.
